(19) United States
(12) Patent Application Publication
(10) Pub. No.: US 2019/0127287 A1
(43) Pub. Date: May 2, 2019

(54) SYSTEM AND METHOD FOR MANUFACTURING A FERTILIZER FROM ANIMAL MANURE

(71) Applicant: ATCOM FERTILIZERS, Deerfield Beach, FL (US)

(72) Inventor: João Alfredo de Araujo, Aracruz (BR)

(21) Appl. No.: 16/177,980

(22) Filed: Nov. 1, 2018

Related U.S. Application Data
(60) Provisional application No. 62/579,952, filed on Nov. 1, 2017.

(51) Int. Cl. C05F 3/06

(52) U.S. Cl. CPC C05F 3/06

(57) ABSTRACT

A system and method of manufacturing organic and organomineral fertilizer from animal manure such as, but not limited to, poultry, pork and beef manure, is provided. In a main step of the method, hydroxides and/or oxides are added to the manure causing a chemical reaction which produces a thermal shock that reduces or eliminates foul-smelling gases and inertizes seeds, bacteria, viruses, nematodes, protozoa, fungi and/or other environmental passive present in the manure. Water vapor liberated by the chemical reaction can be liquefied and mixed with the manure to provide a more liquid resulting product. Macro and micronutrients may be added to the manure.

### CROSS-REFERENCE TO RELATED APPLICATION

This application claims the benefit of U.S. Provisional Patent Application Ser. No. 62/579,952, filed on Nov. 1, 2017, which is incorporated herein in its entirety.

### FIELD OF THE INVENTION

The present invention relates generally to a system and method for manufacturing a fertilizer using animal manure. More particularly, the invention refers to a method comprising the addition of hydroxides and/or oxides to the manure causing a chemical reaction which produces a thermal shock that reduces or eliminates bad smell and environmental passives within the manure, and in which water vapor liberated by the chemical reaction can be liquefied and mixed with the manure to provide a more liquid resulting product.

### BACKGROUND OF THE INVENTION

Soil degradation is as old as agriculture itself, and its impact on human food production and the environment is becoming more severe than ever because of its extent and intensity. Soil impoverishment, as well as growing demand for food, is increasing the use of fertilizers. For example, world fertilizer demand was 184.6 million tons in 2014 and demand is expected to reach 200.2 million tons by 2019 [Heffer P., Prud'homme M.; Fertilizer Outlook 2015-2019; 83^{rd} International Fertilizer Industry Association (IFA) Annual Conference Summary Report; 2015].

For many years, the main purpose of fertilizers has been to provide nutrients to increase or maintain the productivity of a crop. However, fertilizers that are poorly used can become a source of soil, water and air pollution due to nitrate leaching into soil water, emission of greenhouse gases (nitrous oxides), soil contamination with heavy metals and aquatic eutrophication. To illustrate, half of the fertilizers applied, depending on the application method and the soil condition, are lost to the environment; this not only causes serious environmental damage but also results in economic losses.

Furthermore, methods of manufacturing fertilizer products may utilize and/or generate contaminants which cause environmental damage and/or are costly to process. For example, the great majority of conventional fertilizers used in agriculture have been obtained from non-renewable sources, which make these conventional fertilizers increasingly scarce, leading to future exploitation difficulties and impacting on their added value.

Accordingly, there is an established need for a fertilizer that solves or contributes to solve at least one of the aforementioned problems.

### SUMMARY OF THE INVENTION

The present invention is directed to a system and method for manufacturing organic and organomineral fertilizer from animal manure such as, but not limited to, poultry, pork and beef manure. In accordance with the invention, hydroxides and/or oxides are added to the manure causing a chemical reaction which produces a thermal shock that reduces or eliminates foul-smelling gases and inertizes seeds, bacteria, viruses, nematodes, protozoa, fungi and/or other environmental passive present in the manure. Water vapor liberated by the chemical reaction can be liquefied and mixed with the manure to provide a more liquid resulting product. In some embodiments, macro and micronutrients may be added to the manure. The full process can be carried out efficiently (e.g., taking less than one hour to fully process the manure) and cost-effectively.

In a first implementation of the invention, a method for manufacturing a fertilizer from animal manure comprises the steps of obtaining animal manure and eliminating bad odors and/or at least one environmental passive within the animal manure by adding at least one hydroxide and/or oxide to the animal manure thereby causing a chemical reaction between the animal manure and the at least one hydroxide and/or oxide which increases the temperature of the animal manure. In some embodiments, the hydroxides can be selected from the group consisting of potassium hydroxide (KOH), calcium hydroxide (Ca(OH)₂), magnesium hydroxide (Mg(OH)₂), copper(II) hydroxide (Cu(OH)₂), aluminum hydroxide (Al(OH)₃), iron(II) hydroxide (Fe(OH)₂) and sodium hydroxide (NaOH). In some embodiments, the oxides can be selected from the group consisting of potassium oxide (K₂O), calcium oxide (CaO), magnesium oxide (MgO), copper(II) oxide (CuO), aluminum oxide (Al₂O₃), iron(III) oxide (Fe₂O₃) and sodium oxide (Na₂O).

In a second aspect, the step of adding at least one hydroxide and/or oxide to the animal manure is carried out in a reactor. The method can further include a step of removing the animal manure from the reactor once the animal manure has reached a peak temperature resulting from the chemical reaction between the animal manure and the at least one hydroxide and/or oxide.

In another aspect, the method can further include a step of condensing water vapor generated by the chemical reaction to obtain liquid water.

In another aspect, the method can further include a step of adding the liquid water to the animal manure.

In another aspect, the method can further include a step of condensing gaseous ammonia generated by the chemical reaction to obtain liquefied ammonia.

In another aspect, the liquefied ammonia can be used to manufacture urea.

In another aspect, the method can further comprise a step of adding the liquefied ammonia to the animal manure.

In another aspect, the method can further include a step of milling the animal manure.

In another aspect, the method can further include a step of screening the animal manure.

In yet another aspect, the method can further include a step of adding at least one macronutrient to the animal manure. The at least one macronutrient can include N, P, K, S, Ca, Mg or a combination thereof.

In another aspect, the method can further include a step of adding at least one micronutrient to the animal manure. The at least one micronutrient can include Cu, Fe, B, Mn, Mo, Si, Zn or a combination thereof.

In another implementation of the invention, a system for manufacturing a fertilizer from animal manure comprises animal manure, at least one hydroxide and/or oxide, and a reactor. The reactor is configured to receive the animal manure and the at least one hydroxide and/or oxide, and to allow for the formation of a mixture thereof. In some embodiments, the hydroxides can be selected from the group consisting of potassium hydroxide (KOH), calcium hydroxide (Ca(OH)₂), magnesium hydroxide (Mg(OH)₂), copper(II) hydroxide (Cu(OH)₂), aluminum hydroxide (Al(OH)₃), iron(II) hydroxide (Fe(OH)₂) and sodium hydroxide (NaOH). In some embodiments, the oxides can be selected from the group consisting of potassium oxide (K₂O), calcium oxide (CaO), magnesium oxide (MgO), copper(II) oxide (CuO), aluminum oxide (Al₂O₃), iron(III) oxide (Fe₂O₃) and sodium oxide (Na₂O). The reactor is also configured to further allow a chemical reaction to take place between the animal manure and the at least one hydroxide and/or oxide, the chemical reaction causing bad odors and/or at least one environmental passive to be reduced or eliminated within the animal manure due to an increase in the temperature of the mixture produced by the chemical reaction. The reactor is further configured to allow for the delivery of the mixture, which is used to prepare a fertilizer.

In a second aspect, the system can further include a heat exchanger configured to condense water vapor and/or gaseous ammonia resulting from the chemical reaction.

In another aspect, the heat exchanger can be in fluid communication with the reactor and configured to transfer condensed water or ammonia generated by the heat exchanger to the reactor.

In another aspect, the heat exchanger can be configured to receive cold water as a cooling agent for condensing the water vapor and/or gaseous ammonia.

In another aspect, the system can further include one or more mills configured to mill the animal manure.

In another aspect, the system can include one or more screens configured to screen the animal manure.

In yet another aspect, the system can further include a tank configured to receive the animal manure and add at least one macronutrient to the animal manure. The at least one macronutrient can include N, P, K, S, Ca, Mg or combinations thereof.

In yet another aspect, the system can further include a tank configured to receive the animal manure and add at least one micronutrient to the animal manure. The at least one micronutrient can include Cu, Fe, B, Mn, Mo, Si, Zn or combinations thereof.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a block diagram of a manure-processing system in accordance with an illustrative embodiment of the invention;

FIG. 2 presents a flowchart showing a method in accordance with an illustrative embodiment of the invention; and

FIG. 3 presents a graph showing the effect on temperature increase resulting from mixing chicken manure with KOH at different concentrations and during variable amounts of time.

Like reference numerals refer to like parts throughout the several views of the drawings.

### DETAILED DESCRIPTION

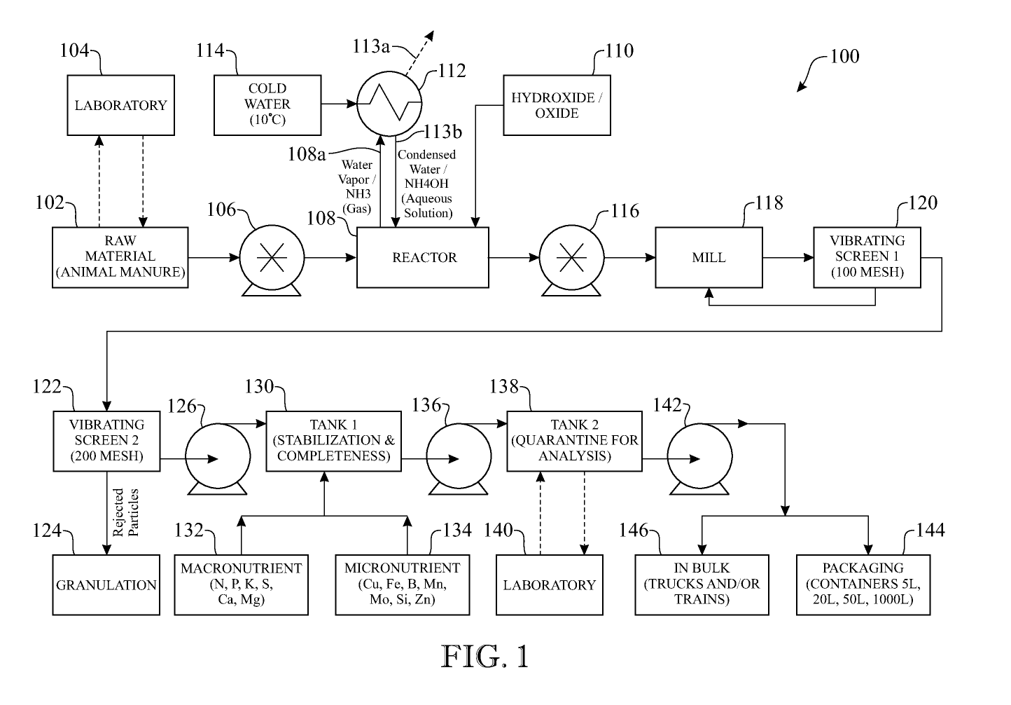

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a system and method of manufacturing a fertilizer using animal manure. More particularly, as will be described hereinafter, the invention refers to a system and method in which hydroxides and/or oxides are added to the manure causing a chemical reaction which produces a thermal shock that reduces or eliminates bad smell and environmental passives within the manure, and in which water vapor liberated by the chemical reaction can be liquefied and then remixed with the manure to provide a more liquid resulting product.

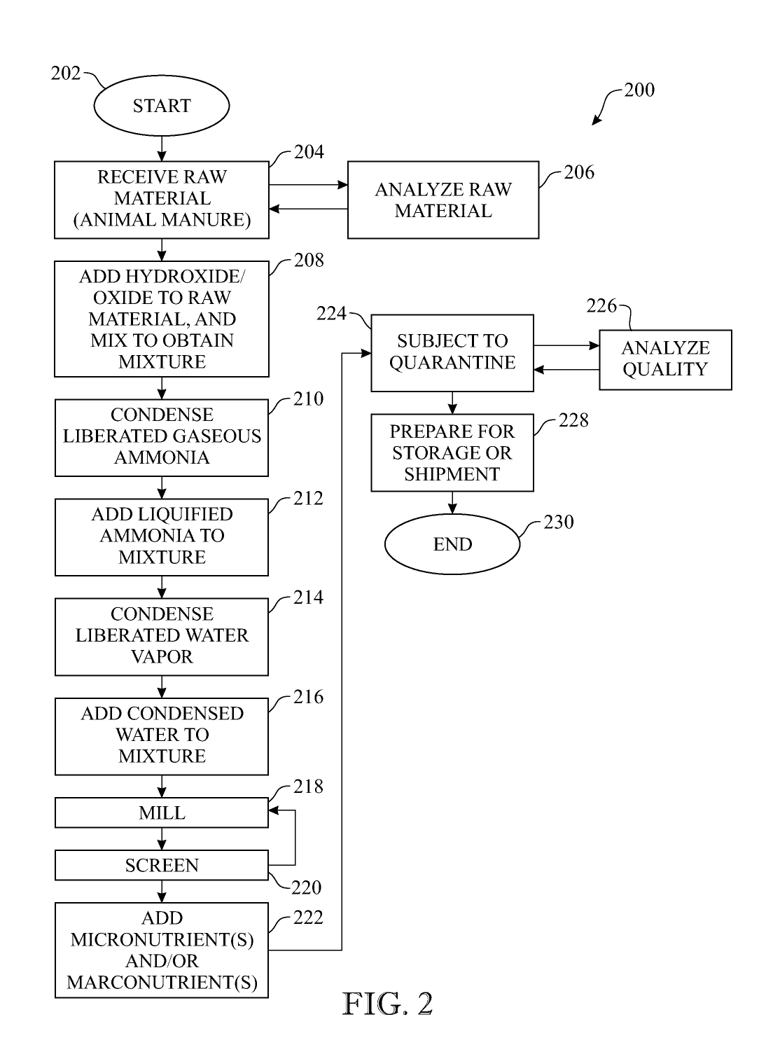

Referring initially to FIGS. 1 and 2, a system 100 and method 200 for manufacturing fertilizers from animal manure are presented, respectively, showing illustrative embodiments of the invention. The system 100 of FIG. 1 is represented by a series of blocks illustrating components and/or materials comprised and utilized in the system. The method 200 of FIG. 2 is presented by a series of steps carried out during the method. The system 100 and method 200 of FIGS. 1 and 2 will be jointly described hereinafter.

As shown in FIG. 2, the method 200 begins at step 202. At step 204, a raw material or animal manure is received. Schematically depicted in FIG. 1, the raw material 102 can include, for instance and without limitation, poultry, pork or beef manure. This raw material 102 will generally have the consistency of a humid, relatively thick and viscose mud, and can be received by a conveyor belt, road transportation, railway transportation or any other applicable means of transportation (not shown in the figures). As indicated by step 206 (FIG. 2), a sample of the raw material 102 can be extracted and sent to a laboratory 104 (FIG. 1) for analysis.

As shown in FIG. 1, the system can further include a first, positive displacement pump 106 and a reactor 108. For instance and without limitation, the reactor 108 can have a capacity of 20 m³. With aid of the first, positive displacement pump 106, the raw material 102 is sent to the reactor 108. As shown in FIG. 1 and also indicated by step 208 in FIG. 2, one or more hydroxides and/or oxides 110 are added to the raw material 102. The hydroxides can be selected from the group consisting of potassium hydroxide (KOH), calcium hydroxide (Ca(OH)₂), magnesium hydroxide (Mg(OH)₂), copper(II) hydroxide (Cu(OH)₂), aluminum hydroxide (Al(OH)₃), iron(II) hydroxide (Fe(OH)₂) and sodium hydroxide (NaOH). In turn, the oxides can be selected from the group consisting of potassium oxide (K₂O), calcium oxide (CaO), magnesium oxide (MgO), copper(II) oxide (CuO), aluminum oxide (Al₂O₃), iron(III) oxide (Fe₂O₃) and sodium oxide (Na₂O). Addition of hydroxide(s) and/or oxide(s) 110 to the raw material 102 causes the hydration and dissociation of the alkali in an aqueous medium provided by the raw material 102. Said hydration and dissociation produce an instant release of heat, or thermal shock, which begins immediately after contact between the water in the raw material 102 and the hydroxide(s) and/or oxides(s) 110. Eventually, the temperature of the mixture of raw material 102 and hydroxide(s) and/or oxides(s) 110 reaches a peak value and then decreases slowly. The temperature variation from room temperature experienced by said mixture can range from 10 to 110° C., for instance and without limitation, depending on the dosage or amount of hydroxides and/or oxides 110 added to the raw material 102.

Preferably, the amount of hydroxides and/or oxides 110 added to the raw material 102 is dependent on the weight of the raw material 102. In order to determine the amount or weight of hydroxides and/or oxides 100 to be added, in some embodiments, the raw material 102 can be weighed in the reactor 108 (for instance by a load cell comprised in the reactor 108) and the amount or weight of hydroxides and/or oxides 110 to be added may be determined as a result of the weighed amount of raw material 102 in the reactor 108. In other embodiments, predetermined amounts or weights of raw material 102 may be inserted into the reactor 108 and predetermined corresponding amounts or weights of hydroxides and/or oxides 110 may be added to the raw material 102 in the reactor 108 accordingly. Preferably, the mixture of raw material 102 with at least one hydroxide and/or oxide 110 includes 1 to 90% in weight of raw material 102, and more preferably, 50 to 70% in weight of raw material 102.

The aforementioned thermal shock resulting from adding at least one hydroxide and/or oxide 110 to the manure or raw material 102 promotes the neutralization of organic acids in the manure, and the inertization of bacteria and enzymes that decompose the proteins present in the manure. As a consequence, bad smell and environmental passive (such as, but not limited to seeds, bacteria, viruses, nematodes, protozoa and fungi) are reduced, and preferably eliminated, from the raw material 102.

A further consequence of the aforementioned chemical reactions between the raw material 102 and the at least one hydroxide and/or oxide 100 is the liberation of heat, gaseous ammonia (NH3) and water vapor. In some embodiments of the invention, the gaseous ammonia and/or water vapor can be utilized in gaseous form for other or external purposes which are not relevant to the present invention. In other embodiments, such as the present embodiment, the gaseous ammonia and/or water vapor can be condensed for further use; for this purpose, the system 100 can include a heat exchanger 112. The heat exchanger 112 can be arranged adjacent to the reactor 108, for instance and without limitation. Cold water 114, such as at a temperature of 10° C., can be fed to the heat exchanger 112 to serve as a cooling agent.

As shown in FIG. 1 and indicated in FIG. 2 by step 210, the gaseous ammonia liberated by the chemical reactions between the raw material 102 and the at least one hydroxide and/or oxide 100 within the reactor 108 can be fed to the heat exchanger 112 as indicated in FIG. 1 by arrow 108a, and can be cooled and liquefied in the heat exchanger 112. In some embodiments, liquefied ammonia (NH4OH) delivered by the heat exchanger 112 as a result of the heat exchange between the cold water 114 and the gaseous ammonia may be discarded or used for further procedures (as indicated schematically by outgoing arrow 113a shown in broken lines) such as, but not limited to, manufacturing urea. Alternatively or additionally, as indicated by arrow 113b in FIG. 1 and step 212 in FIG. 2, liquefied ammonia obtained in the heat exchanger 112 may be returned to the reactor 108 and remixed under agitation with the substances within the reactor 108. Incorporating liquefied ammonia into the mix within the reactor 108 increases the percentage of nitrogen in the mix contained inside the reactor 108 (and thus in the final fertilizer product obtained by the invention) and thus enhances the ability of the final fertilizer product to promote plant growth and stabilization.

As further shown in FIG. 1 and indicated in FIG. 2 by step 214, alternatively or additionally to doing so with gaseous ammonia, water vapor liberated by the chemical reactions between the raw material 102 and the at least one hydroxide and/or oxide 100 within the reactor 108 can be fed to the heat exchanger 112 as indicated in FIG. 1 by arrow 108a, and can be cooled and liquefied in the heat exchanger 112. In some embodiments, liquid water delivered by the heat exchanger 112 as a result of the heat exchange between the cold water 114 and the water vapor may be used for further procedures or discarded, as indicated schematically by outgoing arrow 113a shown in broken lines. Alternatively or additionally, as indicated by arrow 113b in FIG. 1 and step 216 in FIG. 2, said liquid water obtained in the heat exchanger 112 may be returned to the reactor 108 and remixed under agitation with the substances within the reactor 108, contributing to reduce the thickness or viscosity of the material in the reactor 108.

In summary, by means of the thermal shock of step 208, bad smell and environmental passive are reduced or eliminated. Also, by means of the heat exchange steps 210, 212, 214, 216, ammonia and/or water obtained from the manure as a result of the thermal shock can advantageously reutilized within the manure. Specifically, by reutilizing the ammonia as indicated in steps 210 and 212, the percentage of nitrogen in the mixture can be efficiently increased. In turn, by reutilizing water as indicated in steps 214 and 216, the mixture viscosity can be reduced. The resulting mixture delivered by the reactor to further steps of the method is a less viscose mud with little or no bad odors and little or no environmental passive.

After the hydration process of the hydroxides and/or oxides in the medium of the manure, soon after the temperature of the medium within the reactor 108 reaches its isothermal peak, the alkalized manure or raw material 108 is then pumped to one or more mills 118 by a second, positive displacement pump 116, for instance and without limitation. In the one or more mills 118, the product is milled as indicated by step 218 of FIG. 2, producing a milled product.

As indicated in FIG. 2 by step 220, the milled product is then screened so that smaller particles are used in the remaining steps of the method, while larger particles are optionally sent back to the milling step 218 for further milling, thus increasing the milling efficiency. In some embodiments, such as the present embodiment, screening can be carried out in more than one phase. For example, in the present embodiment, the milled product is sent to a first vibrating screen 120, which may have a granulometry of, for instance, 100 mesh. As mentioned, larger, non-filtered particles are sent back to the one or more mills 118 and milling step 218 for further milling. Smaller particles which are filtered by the first vibrating screen 120, in turn, are sent to a second vibrating screen 122 having a smaller mesh size (larger granulometry) than the first vibrating screen 120; for instance and without limitation, the second vibrating screen 122 may have a granulometry of 200 mesh. As a result of the screening process or step 220 of the present embodiment, the size of the largest particle comprised in the mixture is less than 100 micrometers. Particles rejected by the second vibrating screen 122 for being larger than the 200-mesh opening size of the second vibrating screen 122 can be transferred to a separate processing 124 and used for manufacturing different final versions of the fertilizer product. For instance and without limitation, the separate processing 124 can include a granulation process forming larger grains or granules, such as having a size of 1 to 4 millimeters.

With the aid of a third or centrifugal pump 126, the screened product resulting from the screening step 220 (FIG. 2) can be fed to a first tank 130, in which at least one macronutrient 132 and/or at least one micronutrient 134 can be added to the screened product, as also indicated in FIG. 2 by step 222. The at least one macronutrient 132 can include N, P, K, S, Ca, Mg or combinations thereof. The at least one micronutrient 134 can include Cu, Fe, B, Mn, Mo, Si, Zn or combinations thereof. Addition of one or more macro and/or micronutrients completes the fertilizer for replenishment and soil balance and nutrition of the most varied crops. For example, addition of nitrogen enhances the ability of the final fertilizer product to assist in the most important physiological processes that occur in plants, namely: photosynthesis, respiration, root development and activity, ionic absorption of other nutrients, growth, cell differentiation and genetics. Addition of phosphorus, in turn, aims to enhance the metabolism of plants, playing an important role in the transfer of energy (ATP) from the cells and formation of branches and roots. Addition of potassium promotes the growth of plant vegetative tissues, which are constituted of meristematic cells and found in zones of plant growth. In addition, potassium plays an important role in maintaining the amount of water in plants, due to its action on stomatal opening and closure, thus reducing water losses, especially under water stress conditions. Since macro and micronutrients comprise more than 30% of organic material, they highly contribute to the advantages of mineral fertilization and the benefits of organic fertilization, promoting equilibrium in the system relation soil×plant. In summary, addition of macro and/or micronutrients improves soil fertility by acting to increase the exchange capacity (nutrient retention) of the soil, acting as a reservoir of nitrogen, phosphorus and potassium. Said addition also results in an increase in the microbiological activity in the soil due to its high concentration of organic matter, and increases efficiency in the recovery of degraded areas by erosion.

With the aid of a fourth, centrifugal pump 136, the product is then transferred to a second tank 138 where the product remains in quarantine while samples of the product are provided to a laboratory 140. Laboratory tests are carried out in the laboratory 140, as indicated by step 226 in FIG. 2, to ensure the quality of the product.

In a final step 228 shown in FIG. 2, the product is packaged or prepared for storage or shipment. For instance, as shown in FIG. 1, by means of a fifth, centrifugal pump 142, the product can be forwarded to a packaging system 144 in which amounts of the product is packaged in containers or packs of 5, 20, 50 and/or 1000 liters, for instance and without limitation. Alternatively or additionally, amounts of the product can be forwarded to a bulk management system 146 which ships the product in bulk amounts such as by road or railroad transportation. The product is ready to be used in any technological method of application in agriculture, including drip irrigation, sprinkling, micro sprinkling, drenching in the ground, drenching in the lap of the plant.

The process of the present invention therefore transforms an environmental liability (manure) into a fertilizer, aiming to improve soil fertility by increasing the cation exchange capacity (nutrient retention), acting as a reservoir of nitrogen, phosphorus and potassium. The invention provides a fertilizer which promotes increased microbiological activity in the soil, due to its high concentration of organic matter, and consequently increases the capacity of moisture retention, permeability, porosity and stabilization of soil aggregates. Furthermore, the invention saves non-renewable resources and reduces soil, water and air pollution by recycling organic waste (manure).

Alternative embodiments are contemplated to those described heretofore. For instance, the maximum particle size may vary, i.e. milling and grinding may be configured to obtain a maximum particle size other than 100 micrometers, such as, but not limited to, 130 micrometers, 5 micrometers or 1 micrometer. In some embodiments, the screened particles following step 220 can be further refined in colloidal mills with grinding balls, until the condition of 100% below 1 micrometer, i.e. nanoparticles, is achieved.

### Example 1

The chart below shows the composition and characteristics of a fertilizer which has been manufactured using an illustrative implementation of the method of manufacture of the present invention.

| | Amount | |
|---|---|---|
| Element or Feature | | |
| N | 4.89% | |
| Total P (P₂O₅) | 0.90% | |
| K₂O | 10.49% | |
| Ca | 0.84% | |
| Mg | 0.11% | |
| S | 0.060% | |
| Fe | 0.32% | |
| Mn | 0.79% | |
| Zn | 0.010% | |
| B | 0.0046% | |
| Mo | 0.003% | |
| Humidity 65° C. | 68.33% | |
| Humidity 110° C. | 69.61% | |
| Organic Material | 37.34% | |
| Ash | 62.66% | |
| TOC (Total Organic Carbon) | 9.0% | |
| Density | 1.200 | g/mL |
| Saline Index | 30.93% | |
| pH | 14.00 | |
| Solids | 30.38% | |
| Heavy Metals in Final Product | | |
| As | 0.05 | mg/kg |
| Cd | 0.2 | mg/kg |
| Pb | 0.5 | mg/kg |
| Cr | 0.4 | mg/kg |
| Hg | <0.2 | mg/kg |
| Ni | 0.8 | mg/kg |
| Se | <0.1 | mg/kg |

### Example 2

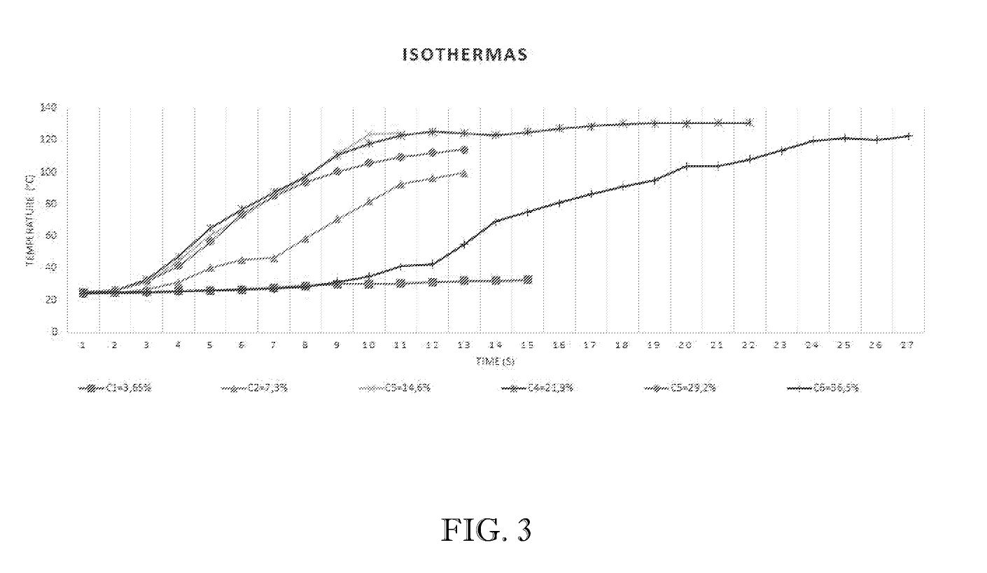

The illustration of FIG. 3 shows the effect on temperature increase in the reactor 108 resulting from adding different concentrations of KOH to a chicken manure raw material 102 during step 208 and allowing chemical reactions to take place during variable periods of time.

In summary, the invention allows to transform an environmental liability (animal manure) into an organomineral, pathogen-free fertilizer which can be used in conventional and organic agriculture, the invention thus saving non-renewable resources and reducing soil, water and air pollution through the recycling of organic waste. The fertilizer can be used or apply in different modalities such as, but not limited to, nutrition, foliar sprays and drench application. The invention can provide a final product which is a complete fertilizer which favors soil physical conditions, such as formation and stabilization of aggregates. The final product contains amino acids, and can also contain macro and/or micronutrients such as N, P, K, Mg, Mn, B and Zn, for instance and without limitation. The fertilizer product can be manufactured at reasonable cost and constitute an affordable product to farmers. The product may be easily stored, such as in boxes, bottles, bags, etc. Furthermore, the invention can contribute to expand the poultry or other animal farming activity by allowing for a correct allocation of waste generated by the activity (this waste or environmental liability constitutes the main source of raw material for the production process and system of the invention).

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A method for manufacturing a fertilizer from animal manure, comprising the steps of:
obtaining animal manure; and
eliminating bad odors and/or at least one environmental passive within the animal manure by adding at least one hydroxide and/or oxide to the animal manure and thereby causing a chemical reaction between the animal manure and the at least one hydroxide and/or oxide which increases the temperature of the animal manure.

2. The method of claim 1, wherein the at least one hydroxide and/or oxide comprises at least one of potassium hydroxide (KOH), calcium hydroxide (Ca(OH)₂), magnesium hydroxide (Mg(OH)₂), copper(II) hydroxide (Cu(OH)₂), aluminum hydroxide (Al(OH)₃), iron(II) hydroxide (Fe(OH)₂) and sodium hydroxide (NaOH).

3. The method of claim 1, wherein the at least one hydroxide and/or oxide comprises at least one of potassium oxide (K₂O), calcium oxide (CaO), magnesium oxide (MgO), copper(II) oxide (CuO), aluminum oxide (Al₂O₃), iron(III) oxide (Fe₂O₃) and sodium oxide (Na₂O).

4. The method of claim 1, wherein adding at least one hydroxide and/or oxide to the animal manure is carried out in a reactor, and further wherein the method additionally comprises a step of removing the animal manure from the reactor once the animal manure has reached a peak temperature resulting from the chemical reaction between the animal manure and the at least one hydroxide and/or oxide.

5. The method of claim 1, further comprising a step of condensing water vapor generated by the chemical reaction to obtain liquid water.

6. The method of claim 5, further comprising a step of adding the liquid water to the animal manure.

7. The method of claim 1, further comprising a step of condensing gaseous ammonia generated by the chemical reaction to obtain liquefied ammonia.

8. The method of claim 7, further comprising a step of manufacturing urea using the liquefied ammonia.

9. The method of claim 7, further comprising a step of adding the liquefied ammonia to the animal manure.

10. The method of claim 1, further comprising a step of milling the animal manure.

11. The method of claim 1, further comprising a step of screening the animal manure.

12. The method of claim 1, further comprising a step of adding at least one macronutrient to the animal manure.

13. The method of claim 1, wherein the at least one macronutrient comprises N, P, K, S, Ca, Mg or a combination thereof.

14. The method of claim 1, further comprising a step of adding at least one micronutrient to the animal manure.

15. The at least one micronutrient comprises Cu, Fe, B, Mn, Mo, Si, Zn or a combination thereof.

16. A method for manufacturing a fertilizer from animal manure, comprising the steps of:
obtaining animal manure;
eliminating bad odors and/or at least one environmental passive within the animal manure by adding at least one hydroxide and/or oxide to the animal manure in a reactor and thereby causing a chemical reaction in the reactor between the animal manure and the at least one hydroxide and/or oxide which increases the temperature of the animal manure; and
removing the animal manure from the reactor once the animal manure has reached a peak temperature resulting from the chemical reaction between the animal manure and the at least one hydroxide and/or oxide.

17. A system for manufacturing a fertilizer from animal manure, comprising:
animal manure;
at least one hydroxide and/or oxide; and
a reactor, configured to receive the animal manure and the at least one hydroxide and/or oxide, to allow for the formation of a mixture thereof, and to further allow bad odors and/or at least one environmental passive to be reduced or eliminated within the animal manure caused by an increase in the temperature of the mixture produced, in turn, by a chemical reaction between the animal manure and the at least one hydroxide and/or oxide, and to further allow for the delivery of the mixture.

18. The system of claim 17, further comprising a heat exchanger configured to condense water vapor and/or gaseous ammonia resulting from the chemical reaction.

19. The system of claim 18, wherein the heat exchanger is in fluid communication with the reactor and is configured to transfer condensed water or ammonia generated by the heat exchanger to the reactor.

20. The system of claim 18, wherein the heat exchanger is configured to receive cold water as a cooling agent for condensing the water vapor and/or gaseous ammonia.

21. The system of claim 17, further comprising one or more mills configured to mill the animal manure.

22. The system of claim 17, further comprising one or more screens configured to screen the animal manure.

23. The system of claim 17, further comprising a tank configured to receive the animal manure and add at least one macronutrient to the animal manure.

24. The system of claim 23, wherein the at least one macronutrient comprises N, P, K, S, Ca, Mg or a combination thereof.

25. The system of claim 17, further comprising a tank configured to receive the animal manure and add at least one micronutrient to the animal manure.

26. The system of claim 25, wherein the at least one micronutrient comprises Cu, Fe, B, Mn, Mo, Si, Zn or a combination thereof.
